(19) United States
(12) Patent Application Publication
(10) Pub. No.: US 2013/0262335 A1
(43) Pub. Date: Oct. 3, 2013

(54) COLLECTION AND DELIVERY MANAGEMENT SYSTEM

(71) Applicant: HONDA MOTOR CO., LTD., Tokyo (JP)

(72) Inventors: Hisashi MURAKAMI, SAITAMA (JP); Tomohiro HOSHI, SAITAMA (JP); Junya ONO, SAITAMA (JP); Hiroyuki KANETA, SAITAMA (JP); Noriyuki MORI, SAITAMA (JP); Tsubasa NOSE, SAITAMA (JP); Takahiro OYAMA, SAITAMA (JP)

(73) Assignee: HONDA MOTOR CO., LTD., TOKYO (JP)

(21) Appl. No.: 13/833,335

(22) Filed: Mar. 15, 2013

(30) Foreign Application Priority Data
Mar. 29, 2012 (JP) 2012-077738

(51) Int. Cl. G06Q 10/08

(52) U.S. Cl. CPC G06Q 10/0833
USPC 705/333

(57) ABSTRACT

A collection and delivery management system and method receives and manages information required for collection and delivery work. A vehicle includes an portable terminal mounted thereon, which receives vehicle state information. The portable terminal determines a state of the collection and delivery work, requests collection and delivery information on cargoes to be collected and delivered to a server, and displays the collection and delivery information. The portable terminal includes an input screen for inputting route completion data corresponding to a result of the collection and delivery work executed, and transmits such route completion data to the server, which transmits the collection and delivery information to the portable terminal according to the request from the portable terminal and records information of the result of the collection and delivery work having been transmitted from the portable terminal so as to be tagged to the collection and delivery information having been transmitted.

### CROSS-REFERENCE TO RELATED APPLICATIONS

The present invention claims priority under 35 USC 119 based on Japanese patent application No. 2012-077738, filed Mar. 29, 2012. The entire subject matter of this priority document, including the specification, claims, and drawings thereof, is incorporated by reference herein.

### BACKGROUND OF THE INVENTION

1. Field of the Invention

The present invention relates to a collection and delivery management system that manages cargos collected and delivered in collection and delivery service of executing collection and delivery using a vehicle.

2. Description of the Background Art

From the past, a vehicle has been used when a delivery agent collects and delivers cargos (referred to also as “collected and delivered articles”). To a cargo collected and delivered by the delivery agent, information of description of the cargo and information of a collection and delivery destination are tagged, and a delivery staff executes collection and delivery work so as to surely execute delivery to the collection and delivery destination or surely execute collection from the collection and delivery destination based on the information tagged to respective cargos.

In delivery agents, as shown in Patent Literature 1 for example, collection and delivery work is managed by portable terminals carried by respective delivery staffs. In Patent Literature 1, disclosed is a portable system for delivery service that prevents deterioration of the service such as delayed delivery and the like by that the portable terminals carried by the respective delivery staffs store positional information provided by a GPS satellite being associated with temporal information. Further in the portable system for delivery service disclosed in Patent Literature 1, it is also disclosed that the delivery service and reporting are facilitated by that the portable terminal stores code information read by a code reading portable device and temporal information in a manner associated with each other.

Also, in recent years, development of saddle-ride type electric vehicles traveling by an electric motor driven by electric power supplied from a battery has been in progress. Therefore, cases have been increasing in which delivery agents utilize the saddle-ride type electric vehicles for collection and delivery of cargos (collected and delivered articles).
[Patent Literature 1] JP-A No. 2008-37563

### Technical Problems

According to a technology disclosed in Patent Literature 1, work of reading the code information by the code reading portable device (transmission of the code information to the portable terminal) and work of inputting delivery information that expresses whether delivery has been completed or not are executed, and the portable terminal is made store information of each. Accordingly, in collection and delivery work, the delivery staff is required to be headed to customers always carrying the portable terminal along with the cargos. Also, the delivery staff is required to execute work of making the portable terminal store each information every time arriving at a collection and delivery destination, that is, even when the cargos cannot be delivered due to a reason that the customer at the collection and delivery destination is absent and the like, there is a case that operation of the portable terminal during collection and delivery work becomes complicated in the actual collection and delivery work.

### SUMMARY OF THE INVENTION

The present invention was developed based on recognition of the problems described above and its object is to provide a collection and delivery management system capable of inputting information required for collection and delivery work and capable of managing the collection and delivery work even when the portable terminal is not carried.

A first aspect of the disclosed invention includes a collection and delivery management system (10) that manages results of collection and delivery of cargos using a vehicle (1) by that a portable terminal (2) and a collection and delivery management server (3) communicate with each other, in which the vehicle (1) includes a vehicle state outputting unit (140) that outputs vehicle state information that expresses a state of the vehicle (1), the portable terminal (2) is detachably attached to the vehicle (1), determines a state of collection and delivery work based on the vehicle state information, requests collection and delivery information on the cargos to be collected and delivered to the collection and delivery management server (3) according to the state of the collection and delivery work determined, displays the collection and delivery information transmitted from the collection and delivery management server (3) according to the request, displays an input screen for inputting results of the collection and delivery work executed according to the collection and delivery information displayed thereto, and transmits information of the results of the collection and delivery work inputted according to the input screen displayed to the collection and delivery management server (3), and the collection and delivery management server (3) transmits the collection and delivery information to the portable terminal (2) according to the request from the portable terminal (2), and records information of the results of the collection and delivery work transmitted from the portable terminal (2) in a manner tagged to the collection and delivery information transmitted.

It is to be understood that the term vehicle includes all vehicles where a rider rides straddling a vehicle body, and includes not only a two-wheeled vehicle but also a three-wheeled vehicle (including vehicles of one front wheel and two rear wheels, and two front wheels and one rear wheel also) or a four-wheeled vehicle.

As a second aspect of the disclosed invention, the portable terminal (2) includes a work state determining unit (210) that determines whether the vehicle (1) has come to a state of capable of traveling or not and whether the vehicle (1) has come to a stopped state or not based on the vehicle state information and determines either a state of starting collection and delivery work or a state of finishing the collection and delivery work based on the determined result, and collection and a delivery result managing unit (220) that transmits information of the request of the collection and delivery information or the results of the collection and delivery work to the collection and delivery management server (3) through a mobile communication network based on the state of the collection and delivery work determined by the work state determining unit (210), and receives the collection and delivery information transmitted according to the request of the collection and delivery information, the work state determining unit (210) determines a state of starting collection and delivery work when the vehicle (1) has come to a state of capable of traveling, and thereafter determines a state of finishing the collection and delivery work when the vehicle (1) has come to a state of capable of traveling again after the vehicle (1) came to a state of stopping, and the collection and delivery result managing unit (220) transmits a request of the collection and delivery information on the cargos to be collected and delivered in collection and delivery work of this time and makes displaying unit included in the portable terminal (2) display the collection and delivery information transmitted according to the request of the collection and delivery information when the state of the collection and delivery work has come to a state of starting collection and delivery work, and makes the displaying unit display the input screen and transmits information of a result of the collection and delivery work of this time inputted according to the input screen displayed on the displaying unit when the state of the collection and delivery work has come to a state of finishing the collection and delivery work.

As a third aspect of the disclosed invention, the collection and delivery information includes names of collection and delivery destinations where the cargos are collected from and delivered to and kinds of the cargos to be collected from and delivered to the collection and delivery destinations, and the collection and delivery result managing unit (220) makes the displaying unit display a name of a first collection and delivery destination as the collection and delivery information when the state of the collection and delivery work has come to a state of starting collection and delivery work for the first time, thereafter makes the displaying unit display an input screen that displays the name of the first collection and delivery destination having been displayed as the collection and delivery information and an input screen that displays the kind of the cargos to be collected from and delivered to the collection and delivery destination in order when the state of the collection and delivery work has come to a state of finishing the collection and delivery work, and makes the displaying unit display a name of a next collection and delivery destination as the collection and delivery information after information of results of collection and delivery work has been inputted according to the respective input screens displayed.

As a fourth aspect of the disclosed invention, the collection and delivery management server (3) includes a route forming unit (330) that forms a route along which the vehicle (1) travels in collection and delivery work of this time, the collection and delivery management server (3) transmits the collection and delivery information on collection and delivery work of this time according to the request from the portable terminal (2) to the portable terminal (2) through the mobile communication network and transmits the route formed to the portable terminal (2) through the mobile communication network, and the collection and delivery result managing unit (220) makes the displaying unit display the route to the collection and delivery destination after having made the displaying unit display the name of the collection and delivery destination as the collection and delivery information.

As a fifth aspect of the disclosed invention, the portable terminal (2) further includes a positional information acquiring unit (240) that acquires positional information of the portable terminal (2), and the collection and delivery result managing unit (220) makes the displaying unit display the positional information of the portable terminal (2) acquired by the positional information acquiring unit (240) on the route in a superimposing manner as a position of the vehicle (1).

As a sixth aspect of the disclosed invention, the collection and delivery information further includes addresses of collection and delivery destinations where the cargos are to be collected from and delivered to, the portable terminal (2) is provided with a navigation function that guides a route, and the collection and delivery result managing unit (220) outputs the addresses of the collection and delivery destinations to the navigation function and makes the displaying unit display the route to the collection and delivery destinations retrieved by the navigation function based on the addresses of the collection and delivery destinations.

As a seventh aspect of the disclosed invention, the vehicle state information includes information whether a main switch (190) included in the vehicle (1) is in an ON state or in an OFF state and information that expresses whether a lid (181a) of a storage box (181) storing the cargos to be collected and delivered furnished in the vehicle (1) is in an opened state or in a closed state, and the work state determining unit (210) determines a state of starting the collection and delivery work when the main switch (190) has been switched to an ON state, and determines a state of finishing the collection and delivery work when the lid (181a) of the storage box (181) becomes an opened state after the main switch (190) has been switched to an OFF state and the state of the main switch (190) is switched to the ON state again.

As a sixth aspect of the disclosed invention, that the vehicle (1) is a saddle-ride type electric vehicle (1) including an electric motor (131) in a power engine (104).

According to the first aspect of the disclosed invention, it is possible that, even if the delivery staff does not carry the portable terminal along with the cargos, collection and delivery information according to a state of each collection and delivery work is displayed on the portable terminal attached to the vehicle and information of the results of the collection and delivery work is acquired from the delivery staff.

According to the second aspect of the disclosed invention, the start and finish of the collection and delivery work can be determined based on a state of the vehicle, and information of each state of each collection and delivery work can be presented to or acquired from the delivery staff.

According to the third aspect of the disclosed invention, appropriate information can be presented to or acquired from the delivery staff for each state of each collection and delivery work.

According to the fourth aspect of the disclosed invention, the route used in executing collection and delivery work can be presented to the delivery staff.

According to the fifth aspect of the disclosed invention, the position where the vehicle is traveling can be presented to the delivery staff along with the route.

According to the sixth aspect of the disclosed invention, the route used in executing collection and delivery work can be presented to the delivery staff by using the function possessed by the portable terminal.

According to the seventh aspect of the disclosed invention, start and finish of the collection and delivery work can be determined based on information of the sensor provided in the vehicle.

According to the eighth aspect of the disclosed invention, the collection and delivery management system of the present invention can be applied to saddle-ride type electric vehicles.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is a left side view of a saddle-ride type electric vehicle to which a collection and delivery management system according to an embodiment of the present invention is applied.

FIG. 2 is a block diagram showing a schematic constitution of a control unit controlling travel of a saddle-ride type electric vehicle to which a collection and delivery management system of the present embodiment is applied.

FIG. 3 is a block diagram showing an outline of a system constitution in a collection and delivery management system of the present embodiment.

FIG. 4 is an enlarged view of a handlebar section of a saddle-ride type electric vehicle to which a collection and delivery management system of the present embodiment is applied.

FIG. 5 is a sequence diagram showing a process flow in a collection and delivery management system of the present embodiment.

FIG. 6 is a sequence diagram showing a process flow in a collection and delivery management system of the present embodiment.

FIG. 7 is a sequence diagram showing a process flow in a collection and delivery management system of the present embodiment.

FIG. 8A depicts exemplary method for inputting a result of collection and delivery work in a collection and delivery management system of the present embodiment—showing an example of the confirmation screen displayed first when the work state determination module has determines that the collection and delivery work has been finished and to be in a state of capable of moving to a next collection and delivery destination, and the work state information expressing finish of the collection and delivery work is inputted to the collection and delivery result management module.

FIG. 8B depicts exemplary method for inputting a result of collection and delivery work in a collection and delivery management system—showing an example of the confirmation screen displayed after the customer of the collection and delivery destination has been confirmed by the confirmation screen shown in FIG. 8A.

FIG. 8C depicts exemplary method for inputting a result of collection and delivery work in a collection and delivery management system—showing an example of the confirmation screen of next collection and delivery destination information displayed after the collection and delivery result obtained by the confirmation screen shown in FIG. 8A and FIG. 8B.

### DETAILED DESCRIPTION

An embodiment of the present invention will be described below referring to drawings. In the description of the present embodiment, description will be given for a case where the collection and delivery management system of the present invention is applied to a saddle-ride type electric vehicle. Also, the drawings are to be viewed in the direction of reference signs, and directions of right/left and front/rear are to mean the direction viewed by a rider.

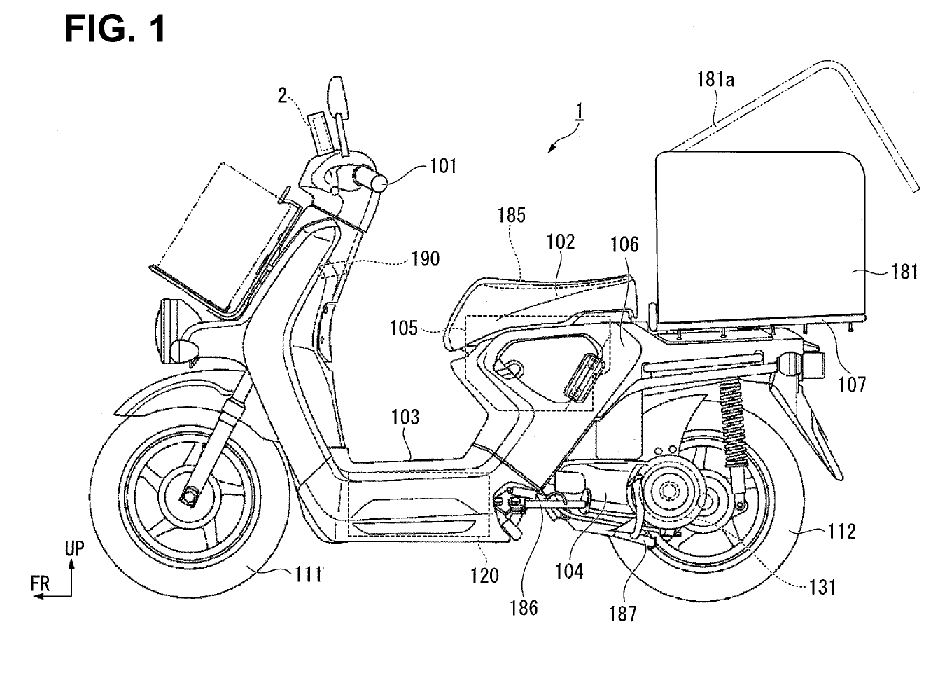

FIG. 1 is a left side view of a saddle-ride type electric vehicle to which a collection and delivery management system according to an embodiment of the present invention is applied. In FIG. 1, shown is an example of a saddle-ride type electric vehicle of a scooter type (hereinafter referred to as “motor-driven two-wheeled vehicle”) having a low floor. A motor-driven two-wheeled vehicle 1 shown in FIG. 1 is provided with a low floor 103 arranged between a handlebar 101 and a seat 102 on which an occupant sits, allowing the occupant to place foots thereon, and covering a battery 120 from above, and includes one each of a front wheel 111 which is a steering wheel and a rear wheel 112 which is a driving wheel.

The motor-driven two-wheeled vehicle 1 travels by that an electric motor 131 incorporated in a swing arm 104 is driven by electric power supplied from the battery 120 mounted inside the low floor 103, and rotational power generated when the electric motor 131 is driven is transmitted to the rear wheel 112. Travel of the motor-driven two-wheeled vehicle 1 is controlled by a control unit arranged in an appropriate position such as inside the swing arm 104, inside an article storage box 105 below the seat 102, the inner side of right and left side covers 106 and the like for example.

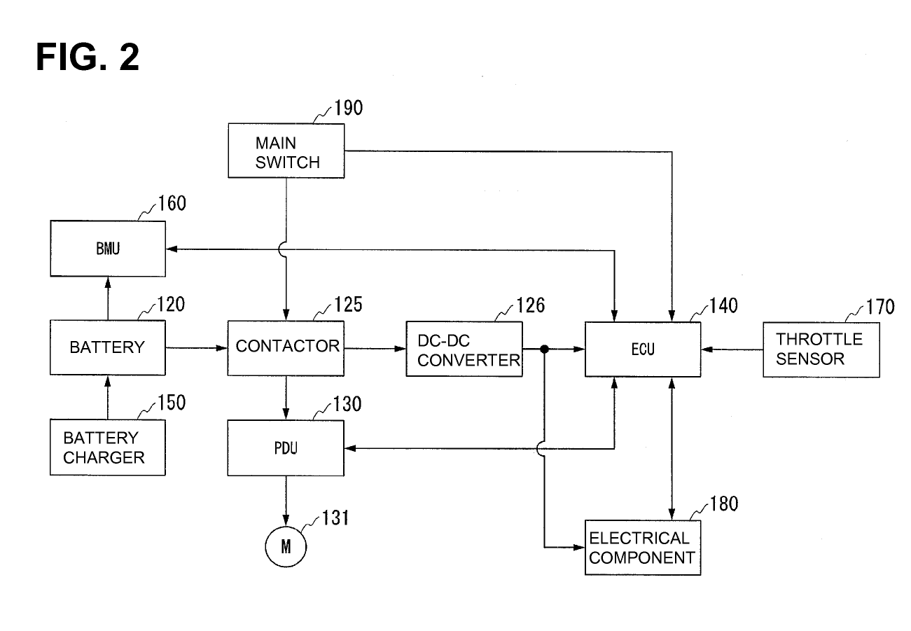

FIG. 2 is a block diagram showing a schematic constitution of the control unit controlling travel of the motor-driven two-wheeled vehicle 1 that is a saddle-ride type electric vehicle to which a collection and delivery management system of the present embodiment is applied.

The battery 120 generates a predetermined high voltage (48 to 72 V for example) by connecting plural numbers of unit battery such as a lithium ion battery, nickel-hydrogen battery, lead battery and the like for example in series. Electric power from the battery 120 is supplied to a PDU (Power Driver Unit) 130 that controls an output of the electric motor 131 through a contactor 125 that is interlocked with a main switch 190 (refer to FIG. 1), is converted from DC to three-phase AC by the PDU 130, and is thereafter supplied to the electric motor 131 that is a three-phase AC motor.

Also, output voltage of the battery 120 outputted through the contactor 125 is stepped down to a low voltage (12 V for example) by a DC-DC converter 126, and is supplied to control system components such as an ECU (Electric Control Unit) 140 and the like. Further, electric power of a low voltage that has been stepped down by the DC-DC converter 126 is supplied to general electrical components 180 such as a sub-battery, lamp and the like not shown.

The battery 120 can be charged by a battery charger 150 connected to a power source of AC 100 V for example. A condition of charging and discharging, temperature, and the like of the battery 120 are monitored by a BMU (Battery Managing Unit) 160, and information of the monitored battery 120 is shared with the ECU 140. Also, in the block diagram shown in FIG. 2, the battery charger 150 also is a constitutional element of the control unit controlling travel of the motor-driven two-wheeled vehicle 1, however the battery charger 150 may be constituted so as to be detachable from the motor-driven two-wheeled vehicle 1.

Information of an output request from a throttle (accelerator) sensor 170 is inputted to the ECU 140, and the ECU 140 controls drive of the electric motor 131 by that the PDU 130 controls electric power supplied to the electric motor 131 based on the information of the output request inputted. Also, information of a control request from a switch not shown operated by a rider is inputted to the ECU 140, and the ECU 140 controls motion of the electrical components 180 based on the information of the control request inputted.

Further, information expressing a state of the motor-driven two-wheeled vehicle 1 such as a state of the main switch 190 operated by the rider using a main key, the result of detection by a sensor not shown provided in the motor-driven two-wheeled vehicle 1, and the like is inputted to the ECU 140, and the ECU 140 outputs the information inputted to a portable terminal described below.

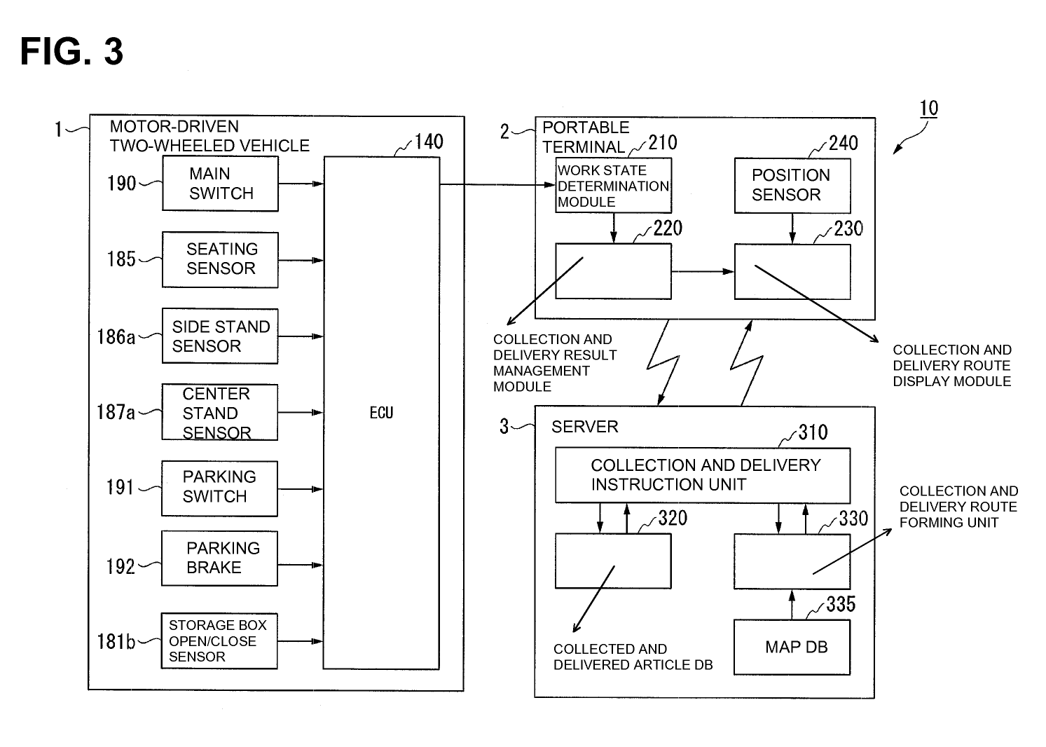

Next, a collection and delivery management system of the present embodiment will be described. FIG. 3 is a block diagram showing an outline of a system constitution in the collection and delivery management system of the present embodiment. The collection and delivery management system 10 of the present embodiment is composed of the motor-driven two-wheeled vehicle 1, a portable terminal 2, and a server 3.

As described above, the motor-driven two-wheeled vehicle 1 outputs information expressing a state of the motor-driven two-wheeled vehicle 1 such as a state of the main switch 190, the result of detection by the sensor not shown provided in the motor-driven two-wheeled vehicle 1, and the like (hereinafter referred to as “vehicle state information”) from the ECU 140 to the portable terminal 2. In the ECU 140 of the collection and delivery management system 10 of the present embodiment shown in FIG. 3, information of whether the main switch 190 is in an ON state or in an OFF state is outputted to the portable terminal 2 as the vehicle state information. Also, the ECU 140 outputs information of a detection result of a storage box open/close sensor 181b that detects a state whether a lid 181a (refer to FIG. 1) of a collected and delivered article storage box 181 attached onto a load carrying platform 107 of the motor-driven two-wheeled vehicle 1 is opened or closed for example is outputted to the portable terminal 2 as the vehicle state information. Based on the vehicle state information of the motor-driven two-wheeled vehicle 1, the portable terminal 2 determines a state of collection and delivery work such as start of the collection and delivery service, finish of each collection and delivery work, and the like.

Also, the vehicle state information outputted to the portable terminal 2 by the ECU 140 is not limited to an example shown in FIG. 3, and may be any information as far as it is information by which the portable terminal 2 can determine the state of the collection and delivery work. For example, information of a result of detection whether a rider rides the motor-driven two-wheeled vehicle 1 by a seating sensor 185 (refer to FIG. 1) that is provided inside the seat 102 and detects an occupant being seated may also be outputted to the portable terminal 2 as the vehicle state information. Also, for example, information of a detection result of a state of a side stand detected by a side stand sensor 186a that detects a state of a side stand 186 (refer to FIG. 1) of the motor-driven two-wheeled vehicle 1 or information of a detection result of a state of a center stand detected by a center stand sensor 187a that detects a state of a center stand 187 (refer to FIG. 1) may also be outputted to the portable terminal 2 as the vehicle state information. Further, for example, information of whether a parking switch 191 and a parking brake 192 not shown operated by the rider are in an ON state or in an OFF state may also be outputted to the portable terminal 2 as the vehicle state information.

The portable terminal 2 is a portable terminal, that is a so-called smart phone for example, combining functions of a cellular phone utilizing an existing mobile communication network and functions of a portable information terminal (PDA: Personal Digital Assistant).

The portable terminal 2 determines a state of the collection and delivery work at present based on the vehicle state information of the motor-driven two-wheeled vehicle 1 inputted from the ECU 140 provided in the motor-driven two-wheeled vehicle 1. Also, the portable terminal 2 transmits a request of information on the collection and delivery service of this time to the server 3 through the mobile communication network based on the state of the collection and delivery work having been determined. Further, the portable terminal 2 presents information of each collection and delivery work included in the information of the collection and delivery service of this time having been transmitted from the server 3 through the mobile communication network to the delivery staff who uses the motor-driven two-wheeled vehicle 1 by displaying it in order on a display part provided in the portable terminal 2 itself based on the state of the collection and delivery work having been determined. Furthermore, the portable terminal 2 transmits information of the result of the collection and delivery work of this time having been inputted by the delivery staff to the server 3 through the mobile communication network as a collection and delivery result based on the state of the collection and delivery work having been determined.

Also, inputting of the result of the collection and delivery work by the delivery staff to the portable terminal 2 is executed from an operation inputting part provided in the portable terminal 2 itself. The operation inputting part can be constituted of a button arranged separately from the display part of the portable terminal 2, however, in the description below, description will be given with the provision that it is a press sensor provided in the display part of the portable terminal 2, that is, a touch panel constituted so as to be combined with the display part. Accordingly, description will be given with the provision that the delivery staff inputs the result of the collection and delivery work from the operation inputting part by executing operation of touching (pushing down, sliding and the like) the display part of the portable terminal 2.

As shown in FIG. 3, the portable terminal 2 includes a work state determination module 210, a collection and delivery result management module 220, a collection and delivery route display module 230, and a position sensor 240. Also, the respective modules provided in the portable terminal 2 are software modules for achieving applications that provide a user of the portable terminal 2, that is, the delivery staff, with the function of the collection and delivery management system 10 of the present embodiment, however, the present embodiment is not limited to it, and it can be a hardware module that achieves the functions of the respective modules.

The work state determination module 210 determines a state of the collection and delivery work at present based on the vehicle state information of the motor-driven two-wheeled vehicle 1 inputted from the ECU 140. Also, the work state determination module 210 outputs information expressing the state of the collection and delivery work having been determined respectively (hereinafter referred to as “work state information”) to the collection and delivery result management module 220.

More specifically, when the state of the main switch 190 included in the vehicle state information having been inputted from the ECU 140 is switched to an ON state, the work state determination module 210 determines a state where the motor-driven two-wheeled vehicle 1 can move (travel), that is, a state where collection and delivery service is to be started. At this time, the work state determination module 210 outputs the work state information expressing start of the collection and delivery service to the collection and delivery result management module 220.

Also, when the state of the main switch 190 included in the vehicle state information having been inputted from the ECU 140 is switched to an OFF state, the work state determination module 210 determines that the motor-driven two-wheeled vehicle 1 has arrived at a location where cargos are to be collected and delivered (collection and delivery destination) and has stopped. Thereafter, when the detection result of the storage box open/close sensor 181b included in the vehicle state information has become a state where the lid 181a of the collected and delivered article storage box 181 opens (OPEN state), it is determined that the delivery staff is executing the collection and delivery work for cargos. Thereafter, when the state of the main switch 190 included in the vehicle state information is switched to an ON state again, it is determined that the collection and delivery work has finished and to be in a state of capable of moving (traveling) to a next collection and delivery destination. At this time, the work state determination module 210 outputs the work state information expressing finish of the collection and delivery work to the collection and delivery result management module 220.

Also, determination of the state of the collection and delivery work by the work state determination module 210 is not limited to an example described above, and may be constituted so as to execute determination combining plural pieces of vehicle state information inputted from the ECU 140. For example, even if the state of the main switch 190 does not become an OFF state, the state where the motor-driven two-wheeled vehicle 1 has arrived at a collection and delivery destination and has stopped can be determined based on the detection result of the stand sensor and the state of the parking switch described above included in the vehicle state information having been inputted from the ECU 140. Also, based on the detection result of the seating sensor 185 described above included in the vehicle state information having been inputted from the ECU 140, the state where the delivery staff has got off the motor-driven two-wheeled vehicle 1 and is executing collection and delivery work of cargos can be determined.

Also, determination of the state of the collection and delivery work by the work state determination module 210 is not limited to that by using only the vehicle state information of the motor-driven two-wheeled vehicle 1 inputted from the ECU 140 described above, and information other than the vehicle state information from the ECU 140 can be also used for determination. For example, by determining whether or not the present position of the motor-driven two-wheeled vehicle 1 is same as the position of the collection and delivery destination (position based on the address of the collection and delivery destination for example) using information such as the present position and the like outputted from the position sensor 240 provided in the portable terminal 2, the state of the collection and delivery work of whether or not the motor-driven two-wheeled vehicle 1 has arrived at the collection and delivery destination can be determined.

The collection and delivery result management module 220 acquires information related to the collection and delivery service of this time from the server 3 based on the work state information having been inputted from the work state determination module 210, and makes the display part provided in the portable terminal 2 itself display information of each collection and delivery work included in information of the collection and delivery service of this time acquired in order.

More specifically, when the work state information expresses start of the collection and delivery service, the collection and delivery result management module 220 requests to the server 3 collection and delivery information including information of all cargos to be collected and delivered in the collection and delivery service of this time, information of respective collection and delivery destinations, and the like and the collection and delivery route in collecting and delivering cargos to the respective collection and delivery destinations. Also, the collection and delivery result management module 220 makes the display part provided in the portable terminal 2 itself display the collection and delivery information having been transmitted from the server 3. Further, the collection and delivery result management module 220 outputs the collection and delivery route having been transmitted from the server 3 to the collection and delivery route display module 230.

Also, based on the work state information having been inputted from the work state determination module 210, the collection and delivery result management module 220 transmits information of the results of the collection and delivery work having been finished to the server 3.

More specifically, when the work state information expresses finish of the collection and delivery work, the collection and delivery result management module 220 makes the display part provided in the portable terminal 2 itself display an input screen (hereinafter referred to as “confirmation screen”) for inputting a result of the collection and delivery work the delivery staff executed this time at the collection and delivery destination at present. Thereby, according to the confirmation screen having been displayed, the delivery staff inputs the result of the collection and delivery work of this time to the portable terminal 2. Also, the collection and delivery result management module 220 transmits information of the result of the collection and delivery work of this time having been inputted by the delivery staff to the server 3 as a collection and delivery result. Thereafter, the collection and delivery result management module 220 makes the display part provided in the portable terminal 2 itself display collection and delivery information of a next delivery destination.

The position sensor 240 is a position sensor such as a GPS (Global Positioning System) and the like for example provided in the portable terminal 2 itself. The position sensor 240 acquires information of the present position of the portable terminal 2, that is, the present position of the motor-driven two-wheeled vehicle 1, and transmits the information of the present position of the motor-driven two-wheeled vehicle 1 acquired to the collection and delivery route display module 230.

The collection and delivery route display module 230 makes the display part provided in the portable terminal 2 itself display the collection and delivery route having been inputted from the collection and delivery result management module 220. At this time, the collection and delivery route display module 230 guides the delivery staff the collection and delivery route by making the display part provided in the portable terminal 2 itself display the information of the present position of the motor-driven two-wheeled vehicle 1 having been inputted from the position sensor 240 in a manner superimposed on the collection and delivery route.

Also, the portable terminal 2 has various kinds of application functions that can be processed as a PDA in addition to an ordinary communication function. For example, there is also a portable terminal 2 having a navigation function that guides a moving direction utilizing information of the present position. When the portable terminal 2 has the navigation function, the collection and delivery route display module 230 can be also constituted so as to guide the collection and delivery route superimposing the collection and delivery route having been inputted from the collection and delivery result management module 220 on the navigation function.

The server 3 is a server managed in a delivery agent or managed in each store of a delivery agent for example, retrieves all cargos to be collected and delivered this time according to a request of information on the collection and delivery service of this time having been transmitted from the portable terminal 2, and transmits the collection and delivery information according to the cargo retrieved to the portable terminal 2 through the mobile communication network. Also, the server 3 forms a collection and delivery route for collecting and delivering the cargos having been retrieved, and transmits the collection and delivery route formed to the portable terminal 2 through the mobile communication network.

As shown in FIG. 3, the server 3 includes a collection and delivery instruction unit 310, a collected and delivered article data base (collected and delivered article DB) 320, a collection and delivery route forming unit 330, and a map data base (map DB) 335.

The collected and delivered article data base 320 is a data base that stores collection and delivery information on each cargo such as the kind of the cargo, time of collection and delivery, address of the collection and delivery destination, name of the customer, and the like. The collected and delivered article data base 320 is retrieved by the collection and delivery instruction unit 310.

Also, the map data base 335 is a data base that stores map information inside a range of collection and delivery. The map data base 335 is referred to by the collection and delivery route forming unit 330.

The collection and delivery instruction unit 310 retrieves collection and delivery information on a cargo to be collected and delivered this time among the collection and delivery information stored in the collected and delivered article data base 320 according to the request of the information on the collection and delivery service of this time having been transmitted from the portable terminal 2, and acquires the collection and delivery information retrieved. Also, the collection and delivery instruction unit 310 makes the collection and delivery route forming unit 330 form a collection and delivery route in collecting and delivering cargos from and to respective collection and delivery destinations included in the collection and delivery information acquired, and acquires the collection and delivery route formed by the collection and delivery route forming unit 330. The collection and delivery instruction unit 310 transmits the collection and delivery information and the collection and delivery route having been acquired to the portable terminal 2. Also, the collection and delivery instruction unit 310 registers (records) the collection and delivery results having been transmitted from the portable terminal 2 in the collected and delivered article data base 320.

The collection and delivery route forming unit 330 forms a collection and delivery route in the collection and delivery service of this time according to the request of forming a collection and delivery route having been inputted from the collection and delivery instruction unit 310, and outputs the collection and delivery route formed to the collection and delivery instruction unit 310. When the collection and delivery route forming unit 330 forms a collection and delivery route, the map data base 355 is referred to, and a collection and delivery route for collecting and delivering all cargos to be collected and delivered this time is formed by a method similar to retrieval of a route to a destination in an existing navigation system for example. In this time, for example, a condition of the collection and delivery route formed can be set such as giving priority to the travel distance, giving priority to the moving time, and the like.

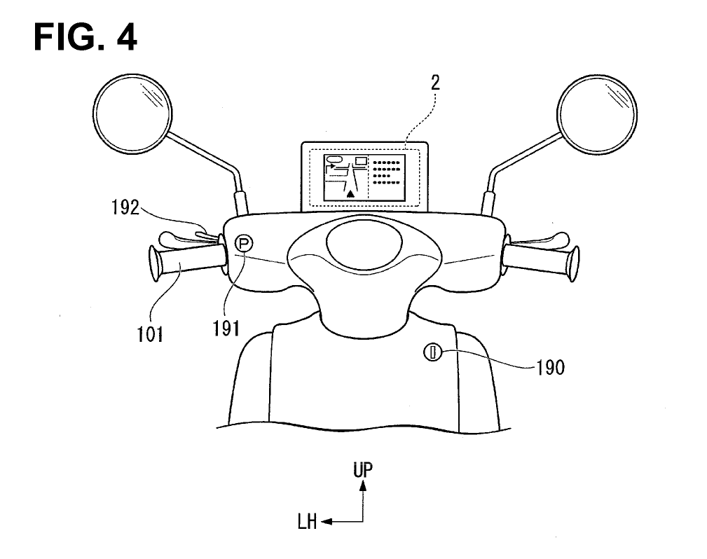

Here, an example of connection between the ECU 140 and the portable terminal 2 provided in the motor-driven two-wheeled vehicle 1 will be described. FIG. 4 is an enlarged view of a handlebar section of the motor-driven two-wheeled vehicle 1 that is a saddle-ride type electric vehicle to which the collection and delivery management system 10 of the present embodiment is applied. The portable terminal 2 is detachably arranged at a predetermined position of the handlebar section of the motor-driven two-wheeled vehicle 1 as shown in FIG. 4, and the ECU 140 and the portable terminal 2 are connected with each other by contact of a signal of the ECU 140 to a connector provided in the portable terminal 2 for example. Also, the portable terminal 2 is constituted so as to be attached and detached only by a user of the portable terminal 2, that is, the delivery staff using the motor-driven two-wheeled vehicle 1, however, detailed description on the constitution and attaching and detaching method thereof will be omitted.

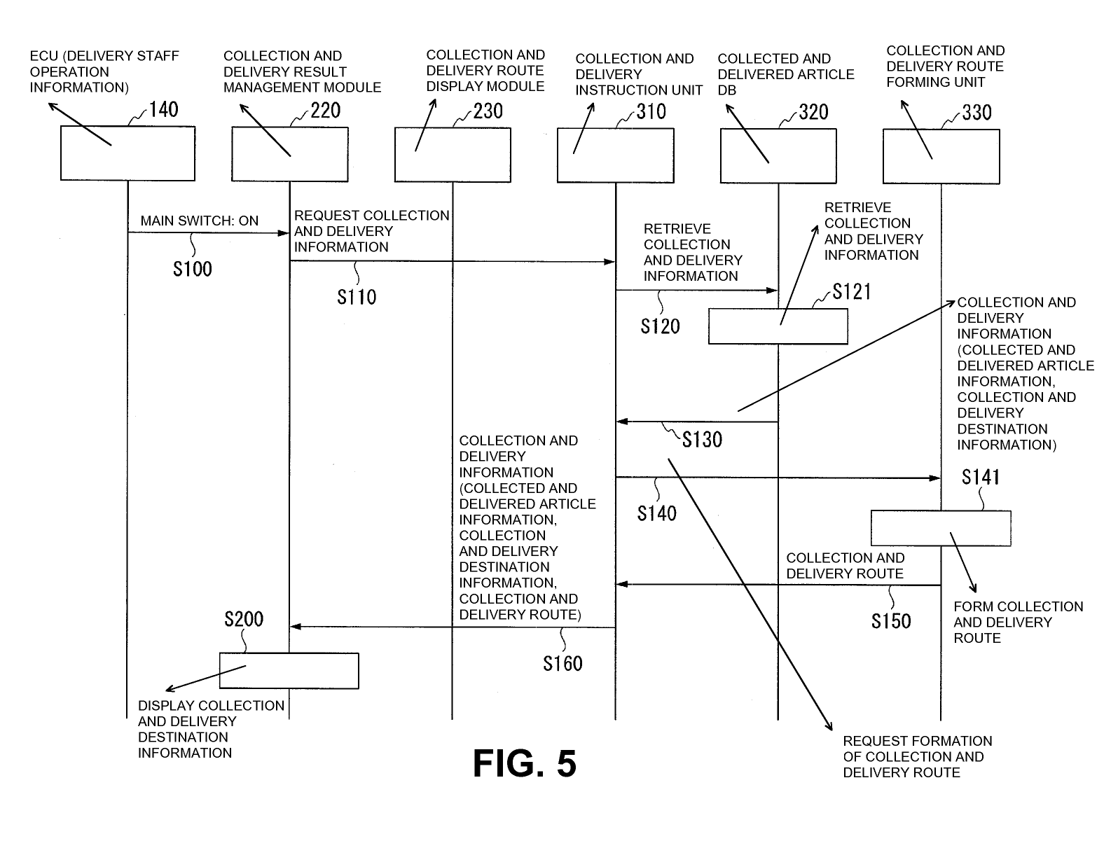

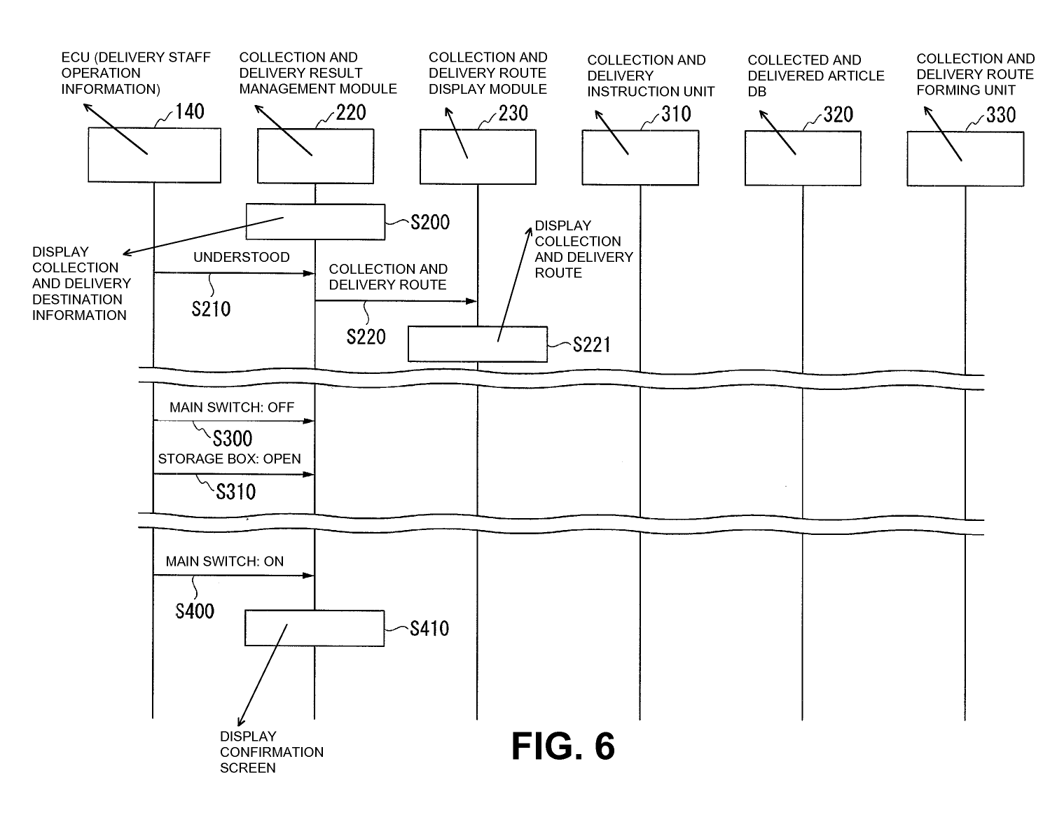

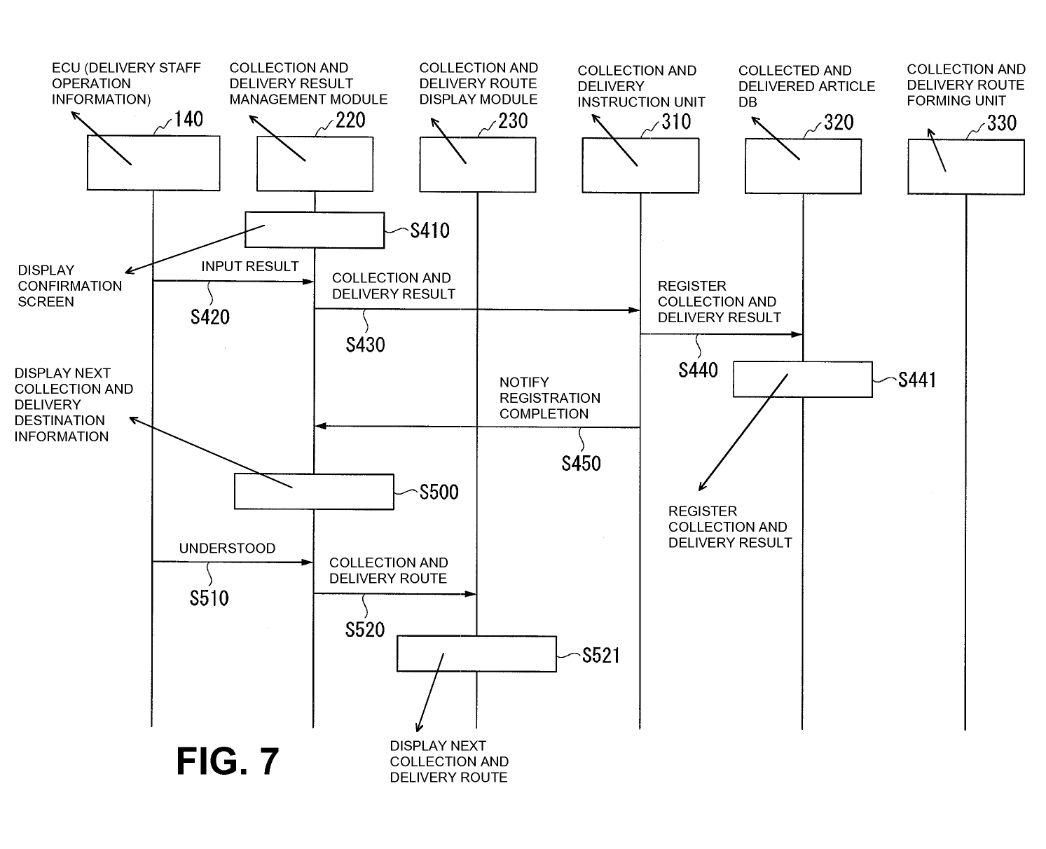

Next, a processing procedure in the collection and delivery management system 10 of the present embodiment will be described. FIG. 5 to FIG. 7 are sequence diagrams showing each process flow in the collection and delivery management system 10 of the present embodiment. In FIG. 5, shown is a process flow from detection of start of the collection and delivery service to acquisition and display of collection and delivery information by the portable terminal 2. Also, in FIG. 6, shown is a process flow from detection of finish of the collection and delivery work to display of a confirmation screen to which the delivery staff inputs a result of collection and delivery work having been executed this time by the portable terminal 2. Further, in FIG. 7, shown is a process flow from transmission of the collection and delivery result having been inputted by the delivery staff to the server 3 to display of collection and delivery information of a next delivery destination by the portable terminal 2.

First, the process flow to acquisition and display of the collection and delivery information shown in FIG. 5 will be described. In starting collection and delivery utilizing the collection and delivery management system 10, first, in step S100, the delivery staff switches the main switch 190 of the motor-driven two-wheeled vehicle 1 to an ON state using a main key. Thereby, vehicle state information expressing that the state of the main switch 190 has been switched to an ON state is outputted from the ECU 140, and the work state determination module 210 determines that the motor-driven two-wheeled vehicle 1 has become a state of capable of moving (traveling) and outputs work state information expressing start of collection and delivery service to the collection and delivery result management module 220. Also, the work state information expressing the start of the collection and delivery service in step S100 may be outputted to the collection and delivery result management module 220 by operation of the portable terminal 2 by the delivery staff in addition to ON of the main switch 190.

Then, when the work state information expressing the start of the collection and delivery service is inputted from the work state determination module 210, in step S110, the collection and delivery result management module 220 transmits a request for collection and delivery information on collection and delivery service of this time to the server 3 (collection and delivery instruction unit 310).

Next, in step S120, according to the request for the collection and delivery information having been transmitted from the portable terminal 2 (collection and delivery result management module 220), the collection and delivery instruction unit 310 retrieves collection and delivery information of the collection and delivery service of this time. In collection and delivery information retrieval in step S121, collected and delivered article information including kinds of all cargos to be collected and delivered in the collection and delivery service of this time and collection and delivery destination information including addresses and names of customers of respective collection and delivery destinations are retrieved. Also, in step S130, the collection and delivery instruction unit 310 acquires the collection and delivery information (collected and delivered article information and collection and delivery destination information) having been retrieved.

Then, in step S140, the collection and delivery instruction unit 310 outputs the collection and delivery destination information included in the collection and delivery information having been acquired to the collection and delivery route forming unit 330, and requests formation of a collection and delivery route in the collection and delivery service of this time. Thereby, in step S141, the collection and delivery route forming unit 330 refers to the map data base 335, forms a collection and delivery route allowing returning after going through all collection and delivery destinations included in the collection and delivery destination information having been inputted from the collection and delivery instruction unit 310, and outputs the collection and delivery route formed to the collection and delivery instruction unit 310. Also, in step S150, the collection and delivery instruction unit 310 acquires the collection and delivery route having been outputted by the collection and delivery route forming unit 330.

Then, in step S160, the collection and delivery instruction unit 310 transmits the collection and delivery information (collected and delivered article information, collection and delivery destination information, and collection and delivery route) acquired to the portable terminal 2 (collection and delivery result management module 220).

Then, in step S200, the collection and delivery result management module 220 makes the display part provided in the portable terminal 2 itself display the collection and delivery destination information included in the collection and delivery information having been transmitted from the server 3 (collection and delivery instruction unit 310). Thereafter, the delivery staff confirms the collection and delivery information (collection and delivery destination information) displayed on the display part of the portable terminal 2, and starts collection and delivery service.

Next, the process flow from detection of finish of the collection and delivery work to display of a confirmation screen shown in FIG. 6 will be described. When the collection and delivery destination information is displayed on the display part of the portable terminal 2 in step S200, first, in step S210, the delivery staff inputs that the collection and delivery destination information has been confirmed and understood from an operation inputting unit provided in the portable terminal 2 itself by executing operation of touching (pushing down, sliding and the like) the display part of the portable terminal 2. Thereby, in step S220, the collection and delivery result management module 220 outputs the collection and delivery route included in the collection and delivery information having been transmitted from the server 3 (collection and delivery instruction unit 310) to the collection and delivery route display module 230.

Thereafter, in step S221, the collection and delivery route display module 230 makes the display part provided in the portable terminal 2 itself display the collection and delivery route having been inputted from the collection and delivery result management module 220. Thereby, the delivery staff drives the motor-driven two-wheeled vehicle 1 according to the collection and delivery route displayed on the display part of the portable terminal 2, and is headed to a first collection and delivery destination shown in the collection and delivery information (collection and delivery destination information) confirmed.

Thereafter, after arriving at the collection and delivery destination and stopping the motor-driven two-wheeled vehicle 1, in step S300, the delivery staff switches the main switch 190 of the motor-driven two-wheeled vehicle 1 to an OFF state using the main key. Thereby, vehicle state information expressing that the state of the main switch 190 has been switched to an OFF state is outputted from the ECU 140, and the work state determination module 210 determines that the motor-driven two-wheeled vehicle 1 has arrived at the collection and delivery destination and has stopped. Thereafter, the delivery staff gets off the motor-driven two-wheeled vehicle 1, and opens the lid 181a of the collected and delivered article storage box 181 in step S310. Thereby, the storage box open/close sensor 181b detects that the lid 181a of the collected and delivered article storage box 181 has opened, vehicle state information expressing that the collected and delivered article storage box has become an OPEN state is outputted from the ECU 140, and the work state determination module 210 determines that the delivery staff is executing collection and delivery work of cargos. Also, according to the present embodiment, even when the main switch 190 has been switched to an OFF state, an electric source for inputting and outputting the vehicle state information and activating the ECU 140 is supplied.

Thereafter, after finishing the collection and delivery work at the collection and delivery destination of this time and closing the lid 181a of the collected and delivered article storage box 181, in step S400, the delivery staff switches the main switch 190 of the motor-driven two-wheeled vehicle 1 to an ON state. Thereby, vehicle state information expressing that the state of the main switch 190 has been switched to an ON state is outputted from the ECU 140, and the work state determination module 210 determines that the collection and delivery work has finished and to be in a state of capable of moving (traveling) to a next collection and delivery destination and outputs work state information expressing finish of the collection and delivery work to the collection and delivery result management module 220.

Then, when the work state information expressing finish of the collection and delivery work is inputted from the work state determination module 210, in step S410, the collection and delivery result management module 220 makes the display part provided in the portable terminal 2 itself display a confirmation screen for inputting the result of the collection and delivery work of this time thereto. Thereafter, the delivery staff inputs the result of the collection and delivery work of this time according to the confirmation screen displayed on the display part of the portable terminal 2.

Next, the process flow from transmission of the collection and delivery result to the server 3 to display of the collection and delivery information of the next delivery destination shown in FIG. 7 will be described. When a confirmation screen is displayed on the display part of the portable terminal 2 in step S410, first, in step S420, the delivery staff inputs the result of the collection and delivery work of this time from an operation inputting unit provided in the portable terminal 2 itself by executing operation of touching (pushing down, sliding and the like) the display part of the portable terminal 2. Thereafter, after all information on the collection and delivery work of this time could be inputted by the delivery staff, in step S430, the collection and delivery result management module 220 transmits information of the result of the collection and delivery work of this time having been inputted by the delivery staff to the server 3 (collection and delivery instruction unit 310) as a collection and delivery result at the collection and delivery destination of this time.

Then, in step S440, the collection and delivery instruction unit 310 registers (records) the collection and delivery result having been transmitted from the portable terminal 2 (collection and delivery result management module 220) in the collected and delivered article data base 320. In registering collection and delivery result in step S441, the collection and delivery result having been transmitted from the portable terminal 2 (collection and delivery result management module 220) is registered (recorded) so as to be tagged to the collection and delivery information of the collection and delivery work of this time. Also, in step S450, when registration (recording) of the collection and delivery result to the collected and delivered article data base 320 has been completed, the collection and delivery instruction unit 310 transmits a registration completion notification expressing that registration (recording) has been completed to the portable terminal 2 (collection and delivery result management module 220).

Then, in step S500, when the collection and delivery result management module 220 receives the registration completion notification transmitted from the server 3 (collection and delivery instruction unit 310), the collection and delivery result management module 220 makes the display part provided in the portable terminal 2 itself display next collection and delivery destination information included in the collection and delivery information having been transmitted already from the server 3.

Thereafter, when the delivery staff confirms the collection and delivery information (next collection and delivery destination information) displayed on the display part of the portable terminal 2 and inputs understanding in step S510, in step S520, the collection and delivery result management module 220 outputs a collection and delivery route to the next collection and delivery destination included in the collection and delivery information having been transmitted already from the server 3 to the collection and delivery route display module 230.

Thereafter, in step S521, the collection and delivery route display module 230 makes the display part provided in the portable terminal 2 itself display the collection and delivery route to the next collection and delivery destination having been inputted from the collection and delivery result management module 220. Thereby, the delivery staff drives the motor-driven two-wheeled vehicle 1 according to the next collection and delivery route displayed on the display part of the portable terminal 2, and is headed to the next collection and delivery destination shown in the collection and delivery information (collection and delivery destination information) confirmed.

Since then, in a similar manner, the delivery staff repeats the collection and delivery work and inputting of the result of the collection and delivery work until collection and delivery of all cargos in the collection and delivery service of this time finishes. Also, the collection and delivery management system 10 repeats the processes of step S300 to step S500 shown in FIG. 6 and FIG. 7, and registers the collection and delivery result that is information of the result of each collection and delivery work so as to be tagged to the collection and delivery information of all the cargos collected and delivered in the collection and delivery service of this time.

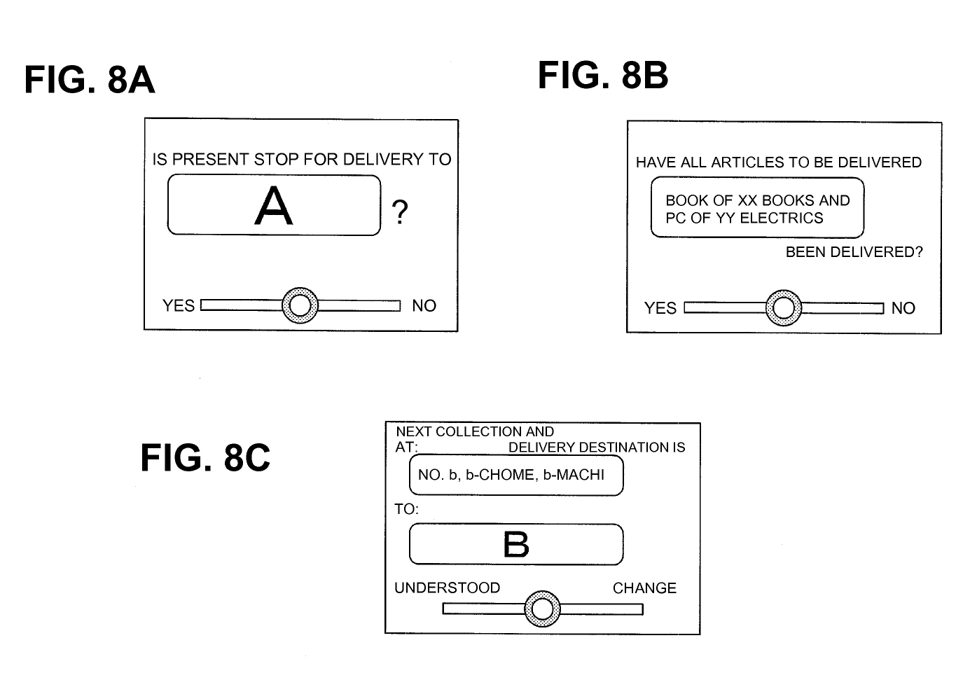

Here, an example of a case will be described in which the confirmation screen is displayed on the display part of the portable terminal 2 arranged in the motor-driven two-wheeled vehicle 1 and the result of the collection and delivery work is inputted thereto. FIG. 8 is a drawing showing an example of a method for inputting the result of the collection and delivery work in the collection and delivery management system 10 of the present embodiment.

In FIG. 8A, shown is an example of the confirmation screen displayed first when the work state determination module 210 has determines that the collection and delivery work has been finished and to be in a state of capable of moving (traveling) to a next collection and delivery destination, and the work state information expressing finish of the collection and delivery work is inputted to the collection and delivery result management module 220. In an example of the confirmation screen shown in FIG. 8A, in order to confirm the customer of the collection and delivery destination in the collection and delivery work of this time, the name of the customer of the collection and delivery destination is displayed. The delivery staff inputs the result of confirmation of the customer of the collection and delivery destination from the operation inputting unit by executing a flick operation of sliding (flicking) the screen toward one direction from a state of being pushed down.

In FIG. 8B, shown is an example of the confirmation screen displayed after the customer of the collection and delivery destination has been confirmed by the confirmation screen shown in FIG. 8A. In an example of the confirmation screen shown in FIG. 8B, in order to confirm the kind of cargos to be collected and delivered in the collection and delivery work of this time, names of all the cargos to be collected and delivered to the collection and delivery destination of this time are displayed. The delivery staff inputs the result of confirmation of the kind of the cargos from the operation inputting unit by executing flick operation. Also, the collection and delivery result management module 220 transmits information of the result of the collection and delivery work of this time having been inputted according to the confirmation screen shown in FIG. 8A and FIG. 8B to the collection and delivery instruction unit 310 of the server 3 as a collection and delivery result at the collection and delivery destination of this time.

In FIG. 8C, shown is an example of the confirmation screen of next collection and delivery destination information displayed after the collection and delivery result obtained by the confirmation screen shown in FIG. 8A and FIG. 8B has been registered (recorded) in the collected and delivered article data base 320 of the server 3. In an example of the confirmation screen of the collection and delivery destination information shown in FIG. 8C, the address and name of the customer of the next collection and delivery destination are displayed as the collection and delivery destination information in the next collection and delivery work. The delivery staff inputs that the address and name of the customer of the next collection and delivery destination have been confirmed and understood from the operation inputting unit by executing flick operation. Also, the delivery staff drives the motor-driven two-wheeled vehicle 1 according to a collection and delivery route displayed thereafter, and is headed to the next collection and delivery destination displayed in the confirmation screen of FIG. 8C.

Further, the confirmation screen displayed in the portable terminal 2 is not limited to the display shown in FIG. 8, and various methods can be devised with respect to a method for inputting the result of the collection and delivery work of this time and a method for presenting the next collection and delivery destination.

As described above, according to the embodiment of the present invention, the portable terminal 2 is attached to a saddle-ride type electric vehicle. Also, the portable terminal 2 determines the state of the collection and delivery work at present based on the information that expresses the state of the vehicle acquired from the saddle-ride type electric vehicle, and displays the confirmation screen to which the information and the collection and delivery route on the cargos to be collected and delivered this time or the result of the collection and delivery work are inputted according to the state of the collection and delivery work at present having been determined. Thereby, even when the delivery staff does not carry the portable terminal 2 all times, information appropriate to each state of each collection and delivery work can be presented to or acquired from the delivery staff.

Thereby, according to the embodiment of the present invention, a collection and delivery management system that can easily manage collection and delivery work without complicating collection and delivery work of a delivery staff can be provided.

Also, in the present embodiment, a case was described which was constituted that the work state determination module 210 determined the state of the collection and delivery work at present and the work state information expressing start of the collection and delivery service and the work state information expressing finish of the collection and delivery work were outputted to the collection and delivery result management module 220. However, determination of the state of the collection and delivery work at present is not limited to the constitution of execution by the work state determination module 210. For example, based on the vehicle state information having been inputted from the ECU 140, the work state determination module 210 determines the state of the motor-driven two-wheeled vehicle 1 at present such as a state the motor-driven two-wheeled vehicle 1 can move (travel), a state the motor-driven two-wheeled vehicle 1 has arrived at a location for collecting and delivering cargos (collection and delivery destination) and has stopped, a state the lid 181a of the collected and delivered article storage box 181 is open (OPEN state), and the like. Further, a constitution is also possible in which the collection and delivery result management module 220 determines the state of the collection and delivery work at present such as start of the collection and delivery service, finish of the collection and delivery work and the like based on the state of the motor-driven two-wheeled vehicle 1 at present having been determined by the work state determination module 210.

Further, in the present embodiment, a case was described in which the collection and delivery route was presented to the delivery staff who was using the motor-driven two-wheeled vehicle 1 by that the server 3 formed the collection and delivery route and the collection and delivery route formed was transmitted to the portable terminal 2 and was displayed on the portable terminal 2. However, formation of the collection and delivery route is not limited to the constitution of execution by the server 3, and, for example, a constitution is also possible in which the collection and delivery route is formed utilizing the navigation function possessed by the portable terminal 2. In this case, the address of the collection and delivery destination included in the collection and delivery information having been transmitted from the collection and delivery instruction unit 310 provided in the server 3 is outputted to the navigation function possessed by the portable terminal 2. Also, in the navigation function possessed by the portable terminal 2, a route to the collection and delivery destination is retrieved from the map information possessed by the navigation function based on the address of the collection and delivery destination having been inputted, and the collection and delivery route is guided to the delivery staff.

Also, at this time, the collection and delivery instruction unit 310 provided in the server 3 can be constituted also so that respective collection and delivery destinations and the order of executing collection and delivery work for all cargos to be collected and delivered in the collection and delivery service of this time are outputted to the navigation function possessed by the portable terminal 2. In this case, the navigation function possessed by the portable terminal 2 can be constituted also so that, based on the addresses of the respective collection and delivery destinations and the order of executing collection and delivery work having been inputted, a route going through all the collection and delivery destinations is retrieved, and routes from the present position to the collection and delivery destinations are guided to the delivery staff in order.

Also, in the present embodiment, a case was described in which, when the portable terminal 2 transmitted the request for the collection and delivery information on the collection and delivery service of this time to the server 3, the server 3 transmitted the collection and delivery information on all cargos to be collected and delivered in the collection and delivery service of this time to the portable terminal 2. However, the constitution of the collection and delivery information transmitted to the portable terminal 2 by the server 3 is not limited to that of the embodiment of the present invention. That is, it is not limited to the constitution of transmitting the collection and delivery information on all cargos to be collected and delivered in the collection and delivery service of this time in one go. For example, after the collection and delivery work has been finished and the collection and delivery result has been transmitted to the server 3, next collection and delivery information is transmitted to the portable terminal 2 from the server 3. That is, in the present embodiment, the collection and delivery information is transmitted to the portable terminal 2 between step S450 and step S500 shown in FIG. 7. Thereby, a series of collection and delivery work executed in the collection and delivery service of this time can be presented to the delivery staff separately to each collection and delivery work. By doing so, it is possible, for example, to present the collection and delivery information to the delivery staff so that, when a customer is absent, the delivery staff executes the collection and delivery work at the collection and delivery destination where the customer was absent again even in the middle of a series of the collection and delivery work, instead of carrying over the customer to the end of the collection and delivery service and being headed to the collection and delivery destination in question again.

Also, in the present embodiment, a case was described in which the map data base 335 stored the map information inside the collection and delivery range, however, information stored by the map data base 335 is not limited to that of the embodiment of the present invention. For example, a constitution is also possible in which each store of a delivery agent stores information of locations where special attention should be paid in driving within the collection and delivery range in charge thereof. By doing so, it is possible that, when the collection and delivery route forming unit 330 forms a collection and delivery route, the information of locations where special attention should be paid in driving which is stored in the map data base 335 is referred to, and a collection and delivery route is formed which allows the delivery staff to be headed to a collection and delivery destination bypassing the locations where special attention should be paid in driving.

Also, in the present embodiment, a case was described in which a portable terminal such as a smart phone and the like was utilized as unit for presenting collection and delivery information and a collection and delivery route to a delivery staff and making the delivery staff input the result of the collection and delivery work, however, the portable terminal may also be a so-called tablet terminal for example that includes a touch panel which is larger than that of a smart phone in general. Further, unit for presenting collection and delivery information and a collection and delivery route to a delivery staff and making the delivery staff input the result of the collection and delivery work is not limited to that of the embodiment of the present invention, and, for example, a constitution is also possible in which a portable terminal for exclusive use is prepared separately, and the portable terminal for exclusive use is made display collection and delivery information and a collection and delivery route as well as a confirmation screen.

Also, in the present embodiment, with respect to connection between the ECU 140 provided in the motor-driven two-wheeled vehicle 1 and the portable terminal 2, an example of connection by wiring utilizing a connector was shown, however a method for connecting the ECU 140 and the portable terminal 2 is not limited to the embodiment of the present invention. For example, the connector may be one having a function of charging as well. Further, the ECU 140 and the portable terminal 2 can be constituted so as to be connected to each other by short distance radio communication such as a Bluetooth (registered trade mark) and the like and a wireless LAN such as WiFi (registered trade mark) and the like for example. Further, it can be also constituted to execute non-contact charging and communication utilizing electromagnetic induction such as the WPC standards and the like for example.

Also, in the present embodiment, a case was described in which the collection and delivery management system of the present invention was applied to a saddle-ride type electric vehicle (motor-driven two-wheeled vehicle 1) of a scooter type having a low floor. However, a vehicle to which the collection and delivery management system of the present invention can be applied is not limited to the motor-driven two-wheeled vehicle 1 described in the present embodiment. For example, the saddle-ride type electric vehicle includes all vehicles where a rider rides straddling a vehicle body, and not only a two-wheeled vehicle but also a three-wheeled vehicle (including vehicles of one front wheel and two rear wheels, and two front wheels and one rear wheel also) or a four-wheeled vehicle are included in the saddle-ride type electric vehicle to which the collection and delivery management system of the embodiments of the present invention can be applied.

Also, in the present embodiment, a case was described in which the collection and delivery management system 10 was applied to the motor-driven two-wheeled vehicle 1 that traveled by driving the electric motor 131, however, a vehicle to which the collection and delivery management system of the embodiment of the present invention can be applied is not limited to a vehicle having a constitution similar to that of the motor-driven two-wheeled vehicle 1 described in the present embodiment. The collection and delivery management system 10 can be applied also to, for example, a two-wheeled vehicle, a three-wheeled vehicle (including vehicles of one front wheel and two rear wheels, and two front wheels and one rear wheel also) and a four-wheeled vehicle traveling by driving an engine which has an internal combustion engine. Further, the collection and delivery management system 10 can be applied to a so-called hybrid vehicle also that has both of an electric motor and an internal combustion engine.

Further, various processes described above in relation with the collection and delivery service using the collection and delivery management system 10 may be executed by recording a program for achieving processing by the server 3 which is a constitutional element of the collection and delivery management system 10 of the present embodiment in a non-transitory computer readable recording medium, making a computer system read the program recorded in the recording medium and executing the program. Also, “computer system” mentioned here may be one that includes an OS and hardware such as a peripheral device and the like. Further, “computer system” is to include home page provision environment (or display environment) if it uses the WWW system. Also, “computer readable recording medium” unit a memory device such as a writable nonvolatile memory such as a flexible disc, magneto-optical disk, ROM, flush memory and the like, a portable medium such as a CD-ROM and the like, a hard disk incorporated in a computer system, and the like.

Furthermore, “computer readable recording medium” is to be inclusive of any non-transitory computer readable mediums include one holding a program for a constant time such as a volatile memory (DRAM (Dynamic Random Access Memory) for example) inside a computer system that becomes a server and a client when the program is transmitted through a network such as the internet and the like and a communication line such as a telephone line and the like. Also, it may be of a type of so-called cloud computing that stores data on the internet. Also, the program may be one for achieving a part of the functions described above. Further, it may be one that can achieve the functions described above by combination with a program already recorded in the computer system, that is, a so-called difference file (difference program).

The embodiment of the present invention has been described above referring to the drawings, however, specific constitutions are not limited to the embodiment, and various alterations within a range not departing from the object of the present invention are also included.

### REFERENCE SIGNS LIST

1 . . . Motor-driven two-wheeled vehicle (vehicle, saddle-ride type electric vehicle)
104 . . . Swing arm (power engine)
107 . . . Load carrying platform
120 . . . Battery
130 . . . PDU
131 . . . Electric motor
140 . . . ECU (vehicle state outputting unit)
160 . . . BMU
180 . . . Electrical component
181 . . . Collected and delivered article storage box (storage box)
181a . . . Lid
181b . . . Storage box open/close sensor
185 . . . Seating sensor
186 . . . Side stand
186a . . . Side stand sensor
187 . . . Center stand
187a . . . Center stand sensor
190 . . . Main switch
191 . . . Parking switch
192 . . . Parking brake
10 . . . Collection and delivery management system
2 . . . Portable terminal
210 . . . Work state determination module (work state determining unit)
220 . . . Collection and delivery result management module (collection and delivery result managing unit)
230 . . . Collection and delivery route display module
240 . . . Position sensor (positional information acquiring unit)
3 . . . Server (collection and delivery managing server)
310 . . . Collection and delivery instruction unit
320 . . . Collected and delivered article data base
330 . . . Collection and delivery route forming unit (route forming unit)
335 . . . Map data base

We claim:

1. A system for managing the collection and delivery of cargos and tracking the results thereof using a portable terminal mounted on a vehicle and a collection and delivery management server communicatively coupled with the portable terminal,
wherein the vehicle includes vehicle state outputting unit that outputs vehicle state information indicating a state of the vehicle;
wherein the portable terminal, which is detachably attached to the vehicle determines a state of collection and delivery work based on the vehicle state information, requests collection and delivery information on the cargos to be collected and delivered from the collection and delivery management server according to the state of the collection and delivery work, displays the collection and delivery information transmitted from the collection and delivery management server according to the request, displays an input screen accepting results of the collection and delivery work executed according to the collection and delivery information displayed thereon, and transmits information of the results of the collection and delivery work inputted according to the input screen to the collection and delivery management server; and
wherein the collection and delivery management server transmits the collection and delivery information to the portable terminal according to the request from the portable terminal, and records information of the results of the collection and delivery work transmitted from the portable terminal in a manner tagged to the transmitted collection and delivery information.

2. The collection and delivery management system according to claim 1, wherein the portable terminal includes:
a work state determining unit that determines whether the vehicle has come to a state of capable of traveling and whether the vehicle has come to a stopped state based on the vehicle state information and determines either a state of starting collection and delivery work or a state of finishing the collection and delivery work based on the determined result; and
a collection and delivery result managing unit that transmits information of the request of the collection and delivery information and the results of the collection and delivery work to the collection and delivery management server through a mobile communication network based on the state of the collection and delivery work determined by the work state determining unit, and receives the collection and delivery information transmitted according to the request of the collection and delivery information,
wherein the work state determining unit:
determines a state of starting collection and delivery work when the vehicle has come to a state of capable of traveling, and
thereafter determines a state of finishing the collection and delivery work when the vehicle has come to a state of capable of traveling again after the vehicle came to a state of stopping, and
wherein the collection and delivery result managing unit:
transmits a request of the collection and delivery information on the cargos to be collected and delivered and causes a displaying unit included in the portable terminal to display the collection and delivery information transmitted according to the request of the collection and delivery information, when the state of the collection and delivery work has come to the state of starting collection and delivery work; and
causes the displaying unit to display the input screen and transmits information of a result of the collection and delivery work inputted according to the input screen, when the state of the collection and delivery work has come to the state of finishing the collection and delivery work.

3. The collection and delivery management system according to claim 2,
wherein the collection and delivery information includes names of collection and delivery destinations where the cargos are collected from and delivered to and descriptions of the cargos to be collected from and delivered to the collection and delivery destinations, and
wherein the collection and delivery result managing unit:
causes the displaying unit to display a name of a first collection and delivery destination as the collection and delivery information, when the state of the collection and delivery work is determined to be the state of starting collection and delivery work for a first time;
thereafter causes the displaying unit to display an input screen that displays the name of the first collection and delivery destination having been displayed as the collection and delivery information and an input screen that displays the kind of the cargos to be collected from and delivered to the collection and delivery destination in order, when the state of the collection and delivery work has come to a state of finishing the collection and delivery work; and
causes the displaying unit to display a name of a next collection and delivery destination as the collection and delivery information after information on the results of collection and delivery work has been inputted according to the respective input screens.

4. The collection and delivery management system according to claim 3,
wherein the collection and delivery management server includes a route forming unit configured to generate a route along which the vehicle travels in collection and delivery work,
wherein the collection and delivery management server transmits the collection and delivery information on collection and delivery work according to the request from the portable terminal to the portable terminal through the mobile communication network and transmits the route to the portable terminal through the mobile communication network, and
wherein the collection and delivery result managing unit causes the displaying unit to display the route to the collection and delivery destination subsequent to causing the displaying unit to display the name of the collection and delivery destination as the collection and delivery information.

5. The collection and delivery management system according to claim 4,
wherein the portable terminal further includes positional information acquiring unit configured to acquire positional information of the portable terminal, and
wherein the collection and delivery result managing unit causes the displaying unit to display the positional information of the portable terminal acquired by the positional information acquiring unit on the route in a superimposing manner as a position of the vehicle.

6. The collection and delivery management system according to claim 3,
wherein the collection and delivery information further includes addresses of collection and delivery destinations where the cargos are to be collected from and delivered to,
wherein the portable terminal is provided with a navigation unit configured to provide navigation information including a route, and
wherein the collection and delivery result managing unit outputs the addresses of the collection and delivery destinations to the navigation unit and causes the displaying unit to display the route to the collection and delivery destinations retrieved by the navigation unit based on the addresses of the collection and delivery destinations.

7. The collection and delivery management system according to claim 2,
wherein the vehicle state information includes information regarding whether a main switch included in the vehicle is in an ON state or in an OFF state and information that expresses whether a lid of a storage box furnished on the vehicle and configured for storing the cargos to be collected and delivered is in an opened state or in a closed state, and
wherein the work state determining unit is configured to:
determine the state of starting the collection and delivery work when the main switch has been switched to the ON state; and
determine the state of finishing the collection and delivery work when the lid of the storage box is in the opened state after the main switch has been switched to the OFF state and the state of the main switch is switched to the ON state again.

8. The collection and delivery management system according to claim 1, wherein the vehicle is a saddle-ride type electric vehicle including an electric motor for propelling the vehicle.

9. A method of managing collection and delivery of cargos and tracking the results thereof using a portable terminal detachably mounted on a vehicle and a collection and delivery management server communicatively coupled with the portable terminal, the method comprising:
outputting vehicle state information indicating a state of the vehicle from a vehicle state outputting unit to the portable terminal;
determining by the portable terminal, a state of collection and delivery work based on the vehicle state information;
requesting, by the portable terminal, collection and delivery information on the cargos to be collected and delivered from the collection and delivery management server according to the state of the collection and delivery work;
receiving from the collection and delivery management server the collection and delivery information according to the request from the portable terminal;
displaying, by the portable terminal, the collection and delivery information transmitted from the collection and delivery management server according to the request;
displaying an input screen configured to accept results of the collection and delivery work executed according to the collection and delivery information displayed thereon;
transmitting information of the results of the collection and delivery work inputted via the input screen to the collection and delivery management server for recordation thereby.

10. The method of managing collection and delivery of cargos according to claim 9, further comprises:
determining a vehicle traveling state to be either a state in which the vehicle is capable of traveling or a state in which the vehicle is stopped based on the vehicle state information using a work state determining unit of the portable terminal; and
determining an work state to be either a state of starting collection and delivery work or a state of finishing the collection and delivery work based on the vehicle traveling state using the work state determining unit of the portable terminal,
wherein the work state determining unit is configured to:
determine the work state to be the state of starting collection and delivery work when the vehicle traveling state is the state in which the vehicle is capable of traveling, and
thereafter determine the work state to be the state of finishing the collection and delivery work when the vehicle traveling state is the state in which the vehicle is capable of traveling subsequent to the vehicle traveling state being the state in which the vehicle is stopped, and
wherein the steps of requesting the collection and delivery information on the cargos to be collected and delivered and displaying the collection and delivery information transmitted according to the request of the collection and delivery information occur when the work state is determined to be the state of starting collection and delivery work; and
wherein the steps of displaying the input screen and transmitting information of the result of the collection and delivery work occur when the work state is determined to be the state of finishing the collection and delivery work.

11. The method of managing collection and delivery of cargos according to claim 10,
wherein the collection and delivery information includes names of collection and delivery destinations where the cargos are collected from and delivered to and descriptions of the cargos to be collected from and delivered to the collection and delivery destinations, and
wherein the step of displaying the collection and delivery information includes displaying a name of a first collection and delivery destination, when the work state is determined to be the state of starting collection and delivery work for a first time;
wherein the step of displaying the input screen includes displaying the name of the first collection and delivery destination and the description of the cargos to be collected from and delivered to the collection and delivery destination, when the work state is determined to be the state of finishing the collection and delivery work; and
wherein the step of displaying the collection and delivery information further includes displaying a name of a next collection and delivery destination as the collection and delivery information after information on the results of collection and delivery work has been inputted via the input screen.

12. The method of managing collection and delivery of cargos according to claim 11,
wherein the collection and delivery information received from the collection and delivery management server includes a route along which the vehicle travels in collection and delivery work generated by a route forming unit of the collection and delivery management server;
wherein the step of displaying the collection and delivery information further includes displaying the route to the collection and delivery destination subsequent to displaying the name of the collection and delivery destination.

13. The method of managing collection and delivery of cargos according to claim 12, further comprising:
acquiring positional information of the portable terminal from a positional information acquiring unit included with the portable unit, and
displaying the positional information of the portable terminal acquired by the positional information acquiring unit on the route in a superimposing manner as a position of the vehicle.

14. The method of managing collection and delivery of cargos according to claim 11,
wherein the collection and delivery information further includes addresses of collection and delivery destinations where the cargos are to be collected from and delivered to,
wherein the portable terminal is provided with a navigation unit configured to provide navigation information including a route based on the addresses of the collection and delivery destinations, and
wherein the step of displaying the collection and delivery information further includes displaying the route.

15. The method of managing collection and delivery of cargos according to claim 10,
wherein the vehicle state information includes: an indication of whether a main switch included in the vehicle is in an ON state or in an OFF state, and an indication of whether a lid of a storage box furnished on the vehicle and configured for storing the cargos to be collected and delivered is in an opened state or in a closed state according to a storage box sensor; and
wherein the work state determining unit is configured to:
determine the work state to be the state of starting the collection and delivery work when the main switch has been switched to the ON state; and
determine the work state to be the state of finishing the collection and delivery work when the lid of the storage box is in the opened state after the main switch has been switched to the OFF state and the state of the main switch is switched to the ON state again.

16. The method of managing collection and delivery of cargos according to claim 9, wherein the vehicle is a saddle-ride type electric vehicle including an electric motor for propelling the vehicle.
